(19) United States
(12) Patent Application Publication
(10) Pub. No.: US 2026/0179992 A1
(43) Pub. Date: Jun. 25, 2026

(54) BRENNSTOFFZELLENVORRICHTUNG, SOWIE BRENNSTOFFZELLENSYSTEM MIT EINER VIELZAHL SOLCHER BRENNSTOFFZELLENVORRICHTUNGEN

(71) Applicant: Robert Bosch GmbH, Stuttgart (DE)

(72) Inventor: Julia Miersch, Stuttgart (DE)

(21) Appl. No.: 18/834,379

(22) PCT Filed: Jan. 19, 2023
(86) PCT No.: PCT/EP2023/051197

§ 371 Date: Aug. 20, 2024

(30) Foreign Application Priority Data
Feb. 1, 2022 (DE) 10 2022 201 017.5

(51) Int. Cl. H01M 8/2475; H01M 8/04007; H01M 8/249

(52) U.S. Cl. CPC H01M 8/2475; H01M 8/04067; H01M 8/249

(57) ABSTRACT

The invention relates to fuel cell device (10) and to a fuel cell system (100) having a plurality of fuel cell devices (10) of this type, the fuel cell device comprising a plurality of fuel cell units (12). It is proposed that the plurality of fuel cell units (12) be disposed in sub-regions (16), which sub-regions (16) should be mutually separated by at least one thermal insulation element (18).

### BACKGROUND

The present invention relates to a fuel cell device comprising a plurality of fuel cell units, and a fuel cell system comprising a plurality fuel cell devices of this type.

Fuel cell devices are known that comprise a plurality of fuel cell units, for example fuel cell stacks.

### SUMMARY

In contrast, the present fuel cell device with the features of the disclosure has the advantage that the plurality of fuel cell units are disposed in sub-regions, which sub-regions are mutually separated by at least one thermal insulation element. This allows for improved temperature distribution within the fuel cell device.

Advantageous further developments of the fuel cell device according to the disclosure are also possible. Thus, it is advantageous for the thermal insulation element to be formed from a thermoplastic foam, thereby enabling cost-effective implementation.

It is also advantageous for the thermal insulation element to completely fill in a space between the sub-regions. This avoids cavities in which explosive gases could collect in the event of a leak. Accordingly, safety may be increased.

It is also advantageous if a different number of fuel cell units is disposed in at least two sub-regions, preferably in at least three sub-regions. As a result, greater flexibility can be achieved with respect to the temperature distribution in the fuel cell device. Also, greater flexibility can be achieved in arranging a plurality of fuel cell devices of this type in a fuel cell system. In particular, this can also reduce the variety of parts.

It is advantageous when at least a first, preferably smallest, number of fuel cell units, in particular a single fuel cell unit, is disposed in at least a first sub-region, a second, preferably average, number of fuel cell units, in particular two fuel cell units, is disposed in at least a second sub-region, and/or a third, preferably highest, number of fuel cell units, in particular four fuel cell units, is disposed in at least a third sub-region. As a result, the flexibility in arranging a plurality of fuel cell devices of this type in a fuel cell system can be increased. In particular, this can also reduce the variety of parts.

It is also advantageous for the fuel cell device to have an outer housing including the sub-regions, thereby enabling simple, modularized handling, in particular also for the arrangement of a plurality fuel cell devices of this type in a fuel cell system.

It is also advantageous if at least one heating unit is disposed in at least one sub-region, whereby the temperature distribution in the fuel cell device and, if necessary, also in an arrangement of a plurality of fuel cell devices of this type in a fuel cell system can be adjusted as needed.

As already mentioned, the invention also relates to a fuel cell system. The fuel cell system includes a plurality of fuel cell devices according to the foregoing description. This allows for improved temperature distribution within the fuel cell system.

Furthermore, advantageous further developments of the fuel cell system are possible. Thus, it is advantageous for the fuel cell devices to be disposed directly next to one another. This allows for a particularly good temperature distribution within the fuel cell system.

It is also advantageous for the fuel cell devices to be disposed next to one another, such that at least a sub-region of a fuel cell device is disposed adjacent to at least a sub-region of another fuel cell device, preferably the same number of fuel cell units. This also allows for a particularly good temperature distribution within the fuel cell system.

It is also advantageous if the fuel cell devices are disposed next to one another, such that at least one thermal insulation element of a fuel cell device is disposed adjacent, preferably in alignment, to at least one thermal insulation element of a further fuel cell device. This also allows for a particularly good temperature distribution within the fuel cell system.

### BRIEF DESCRIPTION OF THE DRAWINGS

Exemplary embodiments of the invention are schematically shown in the drawings and explained in more detail in the subsequent description. Shown are:

FIG. 1 a schematic illustration of an exemplary embodiment of a fuel cell device,

FIG. 2 a schematic illustration of an exemplary embodiment of a fuel cell system having a plurality of fuel cell devices of FIG. 1,

FIG. 3 a schematic illustration of a further exemplary embodiment of a fuel cell device,

FIG. 4 a schematic illustration of another exemplary embodiment of a fuel cell system having a plurality of fuel cell devices of FIG. 3.

### DETAILED DESCRIPTION

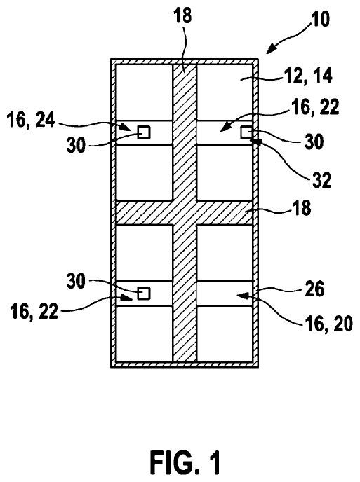

A schematic illustration of an exemplary embodiment of a fuel cell device 10 is shown in FIG. 1. The fuel cell device 10 comprises a plurality of fuel cell units 12, in the present case fuel cell stacks 14, which in turn comprise a plurality of solid oxide fuel cells (SOFC).

The fuel cell device 10 is supplied with a reducing agent, in the present case fuel, specifically natural gas, and an oxidizing agent, in the present case air, and distributed across the fuel cell units 12. The reducing agent, or fuel, is supplied to an anode chamber of a fuel cell unit 12, while the oxidizing agent, or air, is supplied to a cathode chamber of a fuel cell unit 12. In each fuel cell unit 12, the reducing agent, or fuel, is then electrochemically converted with the aid of the oxidizing agent or air, to generate power and heat.

The plurality of fuel cell units 12 are now disposed in sub-regions 16, in the case shown over four sub-regions 16, wherein the sub-regions 16 are mutually separated by at least one thermal insulation element 18, in the case shown by two thermal insulation elements 18. This allows for improved temperature distribution within the fuel cell device 10. This prevents the individual fuel cell units 12 from thermally affecting each other too much, which in turn results in a more homogeneous temperature distribution across the fuel cell device 10 as a whole. It is also avoided that individual fuel cell units 12 with different degrees of aging and degradation will adversely affect each other thermally.

In the exemplary embodiment shown, a plurality of fuel cell units 12, in the case shown two fuel cell units 12 in each case, is again disposed in at least one sub-region 16, in the case shown in each sub-region 16. Thus, it is not absolutely necessary to thermally insulate each fuel cell unit 12 separately, which in turn saves material costs.

In the exemplary embodiment shown, the thermal insulation elements 18 are formed from a thermoplastic foam. This enables cost-efficient implementation.

In the exemplary embodiment shown, the thermal insulation elements 18 completely fill in a space between the sub-regions 16. This avoids cavities in which explosive gases could collect in the event of a leak. Accordingly, safety may be increased.

In the case shown in FIG. 1, the sub-regions 16 each have the same number of fuel cell units 12, in the present case two fuel cell units 12.

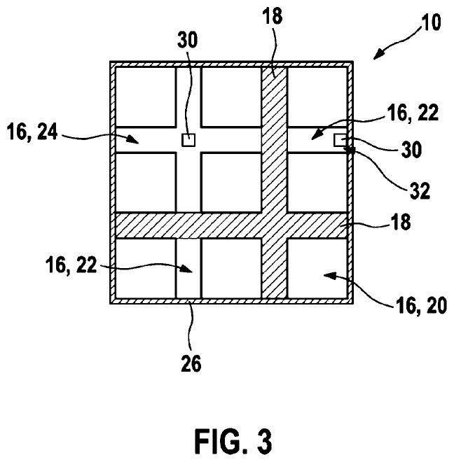

A schematic illustration of a further exemplary embodiment of a fuel cell device 10 is shown in FIG. 3. Unlike the exemplary embodiment shown in FIG. 1, at least two sub-regions 16 of the exemplary embodiment shown in FIG. 3 have a different number of fuel cell units 12. As a result, greater flexibility can be achieved with respect to the temperature distribution in the fuel cell device 10. Also, greater flexibility can be achieved in arranging a plurality of fuel cell devices 10 of this type in a fuel cell system 100. In particular, this can also reduce the variety of parts.

In the exemplary embodiment of the fuel cell device 10 shown in FIG. 3, at least a first, in the present case smallest, number of fuel cell units 12, in the present case a single fuel cell unit 12, are disposed in at least a first sub-region 20, a second, in the present case medium, number of fuel cell units 12, in the present case two fuel cell units 12, are disposed in at least a second sub-region 22, and a third, in the present case highest, number of fuel cell units, in particular four fuel cell units 12, are disposed in at least a third sub-region 24. As a result, the flexibility in arranging a plurality of fuel cell devices 10 of this type in a fuel cell system 100 can be increased. In particular, this can also reduce the variety of parts.

The exemplary embodiments of the fuel cell device 10 shown in the figures each comprise an outer housing, which includes the sub-regions 16. As a result, a simple, modularized handling may be enabled, in particular also for the arrangement of a plurality of fuel cell devices 10 of this type in a fuel cell system 100.

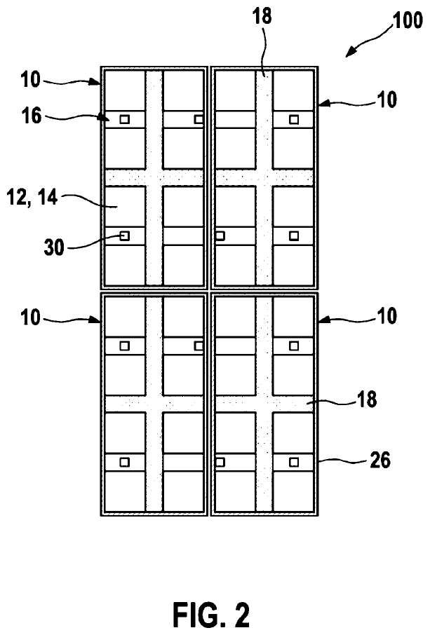

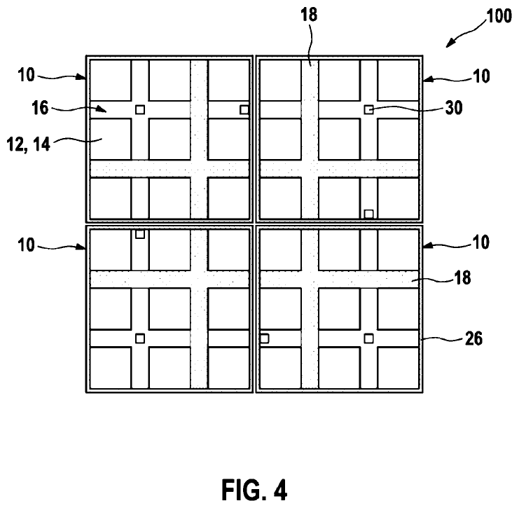

FIG. 2 and FIG. 4 shows schematic diagrams of exemplary embodiments of fuel cell systems 100 with a plurality of fuel cell devices 10. The exemplary embodiment of the fuel cell system 100 of FIG. 2 comprises a plurality of fuel cell devices 10 of FIG. 1, while the exemplary embodiment of the fuel cell system 100 comprises a plurality of fuel cell devices 10 of FIG. 3. This allows for improved temperature distribution within each of the fuel cell systems 100.

In the exemplary embodiments of the fuel cell systems 100 shown, the fuel cell devices 10 are disposed directly next to one another. This allows for a particularly good temperature distribution within each of the fuel cell systems 100.

The fuel cell devices 10 are identical in construction to the fuel cell systems 100 in the embodiments shown. They are disposed in such a way that a respective fuel cell device 10 is disposed rotated by 90° in a plane relative to the adjacent fuel cell device 10. Thus, the embodiment of the fuel cell devices 10 described above enables a simple arrangement in a fuel cell system 100, which does not necessarily require individual adjustments of each fuel cell device 10. Accordingly, both manufacturing and assembly of a fuel cell system 100 is simplified.

In the exemplary embodiments shown, the fuel cell devices 10 are disposed next to one another, such that at least a sub-region 16 of a fuel cell device 10 is disposed adjacent to at least a sub-region 16 of a further fuel cell device 10, in the cases shown with the same number of fuel cell units 12. This also allows for a particularly good temperature distribution within the fuel cell system.

Furthermore, in the exemplary embodiments shown, the fuel cell devices 10 are disposed next to one another, such that at least one thermal insulation element 18 of a fuel cell device is disposed adjacent, in the cases shown in alignment, to at least one thermal insulation element 18 of a further fuel cell device 10. This also allows for a particularly good temperature distribution within the fuel cell system.

Moreover, in the exemplary embodiments of the fuel cell devices 10 shown in FIG. 1 and FIG. 2, at least one heating unit 30 is now disposed in at least one sub-region 16. This allows for adjustment of the temperature distribution within the respective fuel cell devices 10.

In the exemplary embodiments shown, at least one heating unit 30 is disposed in at least one sub-region 16 at the same distance to all fuel cell units 12 located in that sub-region 16. As a result, the adjustment of the temperature distribution with this heating unit 30 can be made uniformly for a plurality of fuel cell units 12 in this sub-region 16.

Furthermore, in the exemplary embodiments shown, at least one heating unit 30 is disposed on an edge 32 of this sub-region 16 in at least one sub-region 16. As a result, the temperature distribution with a heating unit 30 can also be adjusted for adjacent sub-regions 16, in particular adjacent fuel cell devices 10 within a fuel cell system 100.

In addition, in the exemplary embodiments shown, no heating unit 30 is disposed in at least one sub-region 16, whereby in these sub-regions 16 it is possible to specifically dispense with an adjustment of the temperature distribution and costs can be saved accordingly.

In the exemplary embodiment of FIG. 3, a different number of heating units 30 is disposed in at least two sub-regions 16, in the case shown with a different number of fuel cell units 12. As a result, greater flexibility can be achieved with respect to the adjustment of the temperature distribution in the fuel cell device 10. Greater flexibility in adjusting the temperature distribution can also be achieved when a plurality fuel cell devices 10 of this type are disposed in a fuel cell system 100.

In particular, this can also reduce the variety of parts.

In the exemplary embodiment of FIG. 3, no heating unit 30 is disposed in at least a first sub-region 20 with at least a first, in the present case smallest, number of fuel cell units 12, in particular a single fuel cell unit 12, no heating unit 30 or at least one heating unit 30 is disposed in at least a second sub-region 22 with a second, in the present case medium, number of fuel cell units 12, in particular two fuel cell units 12, and at least one heating unit 30 is disposed in at least a third sub-region 24 with a third, preferably highest, number of fuel cell units 12, in particular four fuel cell units 12. This allows for a particularly good adjustment of the temperature distribution within the fuel cell device. As a result, the flexibility of adjusting the temperature distribution when a plurality of fuel cell devices 10 of this type are disposed in a fuel cell system 100 can be increased. In particular, this can also reduce the variety of parts.

In the exemplary embodiments of the fuel cell systems 100 shown in FIGS. 2 and 4, the fuel cell devices 10 are disposed next to one another in such a way that at least one sub-region 16 of a fuel cell device 12 having at least one heating unit 30, in the cases shown the sub-region 16 in which the heating unit 30 is disposed in an edge 32 of the sub-region 16, is disposed adjacent to at least one sub-region 16 of a further fuel cell devices 10, in the cases shown the same number of fuel cell units 12 having no heating unit 30. This also allows for a particularly good adjustment of the temperature distribution within the fuel cell systems 100.

Furthermore, in the exemplary embodiment of the fuel cell system 100 shown in FIG. 4, the fuel cell devices 10 are disposed next to one another, such that at least a sub-region 16 of a fuel cell device 10 with no heating unit 30 is disposed adjacent to at least a sub-region 16 of a further fuel cell devices 10, in the cases shown with the same number of fuel cell units 12, also with no heating unit 30. This also allows for particularly good adjustment of the temperature distribution within the fuel cell system 100. In particular, in the exemplary embodiment shown, these sub-regions 16 are located in the middle, i.e., are surrounded by all other sub-regions 16.

1. A fuel cell device (10) comprising:
a plurality of fuel cell units (12), wherein
the plurality of fuel cell units (12) are disposed in sub-regions (16),
which sub-regions (16) are mutually separated by at least one thermal insulation element (18).

2. The fuel cell device (10) according to claim 1, wherein the at least one thermal insulation element (18) is formed from a thermoplastic foam.

3. The fuel cell device (10) according to claim 1, wherein the at least one thermal insulation element (18) completely fills a space between the sub-regions (16).

4. The fuel cell device (10) according to claim 1, wherein a different number of fuel cell units (12) is disposed in at least two sub-regions (16),

5. The fuel cell device (10) according to claim 1, wherein a first, number of fuel cell units (12), is disposed in a first sub-region (20), a second, number of fuel cell units (12), is disposed in a second sub-region (22), and/or a third number of fuel cell units (12) is disposed in a third sub-region (24).

6. The fuel cell device (10) according to claim 1, wherein the fuel cell device (10) comprises an outer housing (26) including the sub-regions (16).

7. The fuel cell device (10) according to claim 1, wherein at least one heating unit (30) is disposed in at least one sub-region (16).

8. A fuel cell system (100) comprising a plurality of fuel cell devices (10) according to claim 1.

9. The fuel cell system (100) according to claim 8, wherein the fuel cell devices (10) are disposed directly next to one another.

10. The fuel cell system (100) according to claim 8, wherein the fuel cell devices (10) are disposed next to one another, such that at least one sub-region (16) of a fuel cell device (10) is disposed adjacent to at least one sub-region (16) of a further fuel cell device (10).

11. The fuel cell system (100) according to claim 8, wherein the fuel cell devices (10) are disposed next to one another, such that at least one thermal insulation element (18) of a fuel cell device (10) is disposed adjacent, to at least one thermal insulation element of a further fuel cell device (10).

12. The fuel cell device (10) according to claim 4, wherein a different number of fuel cell units (12) is disposed in at least three sub-regions (16).

13. The fuel cell device (10) according to claim 5, wherein the first number of fuel cell units (12) is one, the second number of fuel cell units (12) is two and the third number of fuel cell units is four.

14. The fuel cell system (100) according to claim 10, wherein the adjacent sub-regions (16) each include the same number of fuel cell devices (10).

15. The fuel cell system (100) according to claim 11, wherein the fuel cell devices (10) are disposed next to one another, such that at least one thermal insulation element (18) of a fuel cell device (10) is aligned with at least one thermal insulation element of a further fuel cell device (10).
